(19) United States
(12) Patent Application Publication
(10) Pub. No.: US 2026/0216709 A1
(43) Pub. Date: Jul. 30, 2026

(54) PREPARATION METHOD FOR HYDROPYROLYSIS CATALYST WITH HIGHER DENSITY; BIOMASS HYDROPYROLYSIS PROCESS USING OBTAINED CATALYST

(71) Applicant: SHELL USA, INC., Houston, TX (US)

(72) Inventors: Rikeshchandra Sharadchandra JOSHI, Bangalore North (IN); Patrick VANDER HOOGERSTRAETE, Wondelgem (BE); Milos ROOSE, Wondelgem (BE); Tom Verschelde, Wondelgem (BE); David Anthony Grisafe, Houston, TX (US); Santosh Ganji, Bangalore (IN)

(21) Appl. No.: 19/144,018

(22) PCT Filed: Jan. 10, 2024
(86) PCT No.: PCT/US2024/010961

§ 371 Date: Jun. 27, 2025

(30) Foreign Application Priority Data
Jan. 13, 2023 (IN) 202341002734

(51) Int. Cl. B01J 27/19; B01J 21/04; B01J 35/31; B01J 35/40; B01J 35/51; B01J 37/00; B01J 37/02; B01J 37/08; C10B 53/02; C10B 57/06; C10G 1/02; C10G 1/08

(52) U.S. Cl. CPC B01J 27/19; B01J 21/04; B01J 35/31; B01J 35/40; B01J 35/51; B01J 37/0018; B01J 37/0063; B01J 37/0201; B01J 37/0236; B01J 37/08; C10B 53/02; C10B 57/06; C10G 1/02; C10G 1/086; C10G 2300/1003; C10G 2300/1014

(57) ABSTRACT

A method of preparing a hydropyrolysis catalyst, includes i) forming a slurry having alpha alumina, an alumina precursor, a binder and water; ii) performing spray granulation of said slurry to prepare solid catalyst or carrier spheres; and iii) drying the catalyst or carrier spheres and then calcining at a temperature in the range of 450° C. and 900° C. Active species including molybdenum and a metal selected from those in groups 8, 9 and 10 of the periodic table are incorporated into the hydropyrolysis catalyst, either by incorporating a molybdenum source and a source of a metal selected from those in groups 8, 9 and 10 of the periodic table into the slurry in step i) or by impregnating the calcined carrier spheres with a solution having a molybdenum source and a source of a metal selected from those in groups 8, 9 and 10 of the periodic table.

### FIELD OF THE INVENTION

This invention relates to a method for the preparation of a hydropyrolysis catalyst.

### BACKGROUND OF THE INVENTION

With increasing demand for liquid transportation fuels, decreasing reserves of ‘easy oil’ (crude petroleum oil that can be accessed and recovered easily) and increasing constraints on the carbon footprints of such fuels, it is becoming increasingly important to develop routes to produce liquid transportation fuels from alternative sources in an efficient manner.

Biomass offers a source of renewable carbon and refers to biological material derived from living or recently deceased organisms and includes lignocellulosic materials (e.g., wood), aquatic materials (e.g., algae, aquatic plants, and seaweed) and animal by-products and wastes (e.g., offal, fats, and sewage sludge). Liquid transportation fuels produced from biomass are sometimes referred to as biofuels. Therefore, when using such biofuels, it may be possible to achieve more sustainable CO-emissions over petroleum-derived fuels.

However, in the conventional pyrolysis of biomass, typically fast pyrolysis carried out in an inert atmosphere, a dense, acidic, reactive liquid bio-oil product is obtained, which contains water, oils and char formed during the process. The use of bio-oils produced via conventional pyrolysis is, therefore, subject to several drawbacks. These include increased chemical reactivity, water miscibility, high oxygen content and low heating value of the product. Often these products are difficult to upgrade to fungible liquid hydrocarbon fuels.

An efficient method for processing biomass into high quality liquid fuels is described in WO2010117437 and subsequent patents describing the IH² process developed by Shell and Gas Technology Institute, such as U.S. Pat. Nos. 10,005,965, 9,868,909, 10,005,964, US20170009143, U.S. Pat. Nos. 10,167,429, 10,526,544, 11,174,438, 10,822,545, 10,174,259, 10,190,056, 10,774,270, 10,829,695, 10,647,924, 10,822,546, 9,657,232, 10,183,279 and WO2022133224. The processes for the conversion of biomass into liquid hydrocarbon fuels described in WO2010117437 use a first hydropyrolysis reaction and a subsequent hydroconversion reaction to convert biomass into useable products.

Solid feedstocks such as feedstocks containing waste plastics and feedstocks containing lignocellulose (e.g., woody biomass, agricultural residues, forestry residues, residues from the wood products and pulp & paper industries and municipal solid waste containing lignocellulosic material) are important feedstocks for biomass to fuel processes due to their availability on a large scale. Lignocellulose comprises a mixture of lignin, cellulose and hemicelluloses in any proportion and usually also contains ash and moisture.

The hydropyrolysis stage of the process described in WO2010117437 utilises a hydropyrolysis catalyst. Typical hydropyrolysis catalysts used in this process comprise a mixture of cobalt or nickel in combination with molybdenum and phosphorus on a gamma alumina carrier. The hydropyrolysis reaction takes place in a bubbling fluidised bed reactor in which biomass is fed to the bottom of the reactor. The biomass is rapidly heated in contact with a hot hydropyrolysis catalyst under a hydrogen atmosphere. The catalyst must have certain properties with respect to size and density in order to achieve a fluidised bed with the necessary flow and reaction. Some catalyst will pass out of the top of the bed and must be separated from the hydropyrolysis product and char. Optimising the density of the catalyst particles would facilitate separation from the char and allow catalyst to quickly pass through downcomers and to be rapidly returned to the main reactor body with minimal heat loss.

As well as being of the correct size and density, the hydropyrolysis catalyst must retain the metal loading ability and surface area required to provide the necessary catalytic activity.

### SUMMARY OF THE INVENTION

The present invention provides a method of preparing a hydropyrolysis catalyst, said process comprising the steps of:
i) forming a slurry comprising alpha alumina, an alumina precursor, a binder and water;
ii) performing spray granulation of said slurry to prepare solid catalyst or carrier spheres; and
iii) drying the catalyst or carrier spheres and then calcining them at a temperature in the range of at least 450° C. and no more than 900° C., wherein active species comprising a molybdenum and a metal selected from those in groups 8, 9 and 10 of the periodic table are incorporated into the hydropyrolysis catalyst, either by incorporating a molybdenum source and a source of a metal selected from those in groups 8, 9 and 10 of the periodic table into the slurry in step i) or by impregnating the calcined carrier spheres with a solution comprising a molybdenum source and a source of a metal selected from those in groups 8, 9 and 10 of the periodic table and subsequently drying and then calcining at a temperature in the range of at least 450° C. and no more than 900° C. the thus-impregnated carrier spheres to provide the hydropyrolysis catalyst.

### DETAILED DESCRIPTION OF THE INVENTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

A process is described herein which can be used to produce a hydropyrolysis catalyst of suitable density and performance for use in a fluidised bed reactor for the rapid hydropyrolysis of biomass. Said process comprises spray granulation of a slurry comprising a mixture of alpha alumina and an alumina precursor as well as a binder and water in order to make spheres of suitable size, density and surface area. In one embodiment of the invention, a molybdenum source and a source of a metal selected from those in groups 8, 9 and 10 of the periodic table are also incorporated into the slurry. The resultant catalyst spheres can then be dried and then calcined at a temperature in the range of at least 450° C. and no more than 900° C. to provide an effective hydropyrolysis catalyst. In an alternative embodiment of the invention, the spheres are catalyst carrier spheres and are then impregnated with a solution of active species comprising a molybdenum source and a source of a metal selected from those in groups 8, 9 and 10 of the periodic table, before further drying and then calcining at a temperature in the range of at least 450° C. and no more than 900° C. to provide an effective hydropyrolysis catalyst.

The catalyst produced in the process of the present invention contains both alpha and a non-alpha alumina, said non-alpha alumina having been formed from the alumina precursor during calcination at a temperature in the range of at least 450° C. and no more than 900° C. These materials act as a carrier to and provide a surface for active species in the hydropyrolysis catalyst.

The alpha alumina is present in the range of from 35 to 60 wt % based on the overall weight of the hydropyrolysis catalyst. Preferably, alpha alumina is present in the range of from 45 to 50 wt % based on the overall weight of the hydropyrolysis catalyst.

The alpha alumina has a particle density of at least 3.5 g/cm³, preferably at least 4.0 g/cm³. Also preferably, the particle density of the alpha alumina is no more than 4.5 g/cm³.

The non-alpha alumina in the hydropyrolysis catalyst is present in the range of from 30 to 50 wt % based on the overall weight of the hydropyrolysis catalyst. Preferably, said non-alpha alumina is present in the range of from 35 to 40 wt % based on the overall weight of the hydropyrolysis catalyst.

The non-alpha alumina has a particle density of at least 0.8 g/cm³, preferably at least 1.0 g/cm³. Also preferably, the particle density of the non-alpha alumina is no more than 1.2 g/cm³.

The particle density of the non-alpha alumina produced from any precursor can readily be measured by calcining a portion of the precursor and measuring the particle density of the alumina thus produced.

The non-alpha alumina may be any alumina which is not alpha alumina. Gamma (γ), chi (χ) and eta (η) aluminas are particularly preferred. The most preferred non-alpha alumina is gamma alumina.

The precursor of the non-alpha alumina is selected from any material that will form a suitable non-alpha, preferably gamma, eta or chi, alumina of a suitable particle density during the method of the present invention. This includes, but is not limited to boehmite, pseudoboehmite, gibbsite, bayerite. A preferred non-alpha alumina is gamma alumina and the preferred non-alpha alumina precursor is pseudoboehmite.

The hydropyrolysis catalyst formed in the process of the inventions also contains molybdenum and a metal selected from those in groups 8, 9 and 10 of the periodic table as active species. For clarity, groups 8, 9 and 10 of the periodic table are those according to “Nomenclature of Inorganic Chemistry”—IUPAC Recommendations 2005. Preferred metals in groups 8, 9 and 10 of the periodic table are selected from one or more of cobalt, iron, nickel, copper and manganese. Even more preferably, the metal or metals in groups 8, 9 and 10 of the periodic table are one or more of cobalt and nickel.

The molybdenum and metal selected from those in groups 8, 9 and 10 of the periodic table may be including in the hydropyrolysis catalyst either by a) incorporating a molybdenum source and a source of a metal selected from those in groups 8, 9 and 10 of the periodic table into the slurry in step i) or b) impregnating the calcined carrier spheres with a solution comprising a molybdenum source and a source of a metal selected from those in groups 8, 9 and 10 of the periodic table and subsequently drying and calcining the thus-impregnated carrier spheres.

Regardless of the means of incorporating the metals into the finished hydropyrolysis catalyst, the metal source is preferably incorporated in an amount to provide a metal content of the metal selected from those in groups 8, 9 and 10 of the periodic table in the hydropyrolysis catalyst in an amount in the range of from 0.5 wt % to 20 wt %, more preferably from 1 wt % to 15 wt %, and, most preferably, from 2 wt % to 12 wt % based on the overall weight of the catalyst.

Regardless of the means of incorporating the molybdenum into the finished hydropyrolysis catalyst, the molybdenum source is preferably incorporated in an amount to provide molybdenum in the hydropyrolysis catalyst in an amount in the range of from 5 wt % to 50 wt %, more preferably from 8 wt % to 40 wt %, and, most preferably, from 12 wt % to 30 wt % based on the overall weight of the catalyst. Suitable sources of the metal selected from those in groups 8, 9 and 10 of the periodic table include, but are not limited to cobalt hydroxide, cobalt oxide, cobalt (II) nitrate hexahydrate, cobalt hydroxycarbonate, Cobalt oxide, nickel hydroxide, nickel hydroxycarbonate, nickel nitrate and nickel oxide.

Suitable molybdenum sources include, but are not limited to, ammonium heptamolybdate, molybdenum trioxide, ammonium dimolybdate and molybdenum dioxide.

It may also be desirable to incorporate phosphorous as an active species in the hydropyrolysis catalyst. This may be incorporated with the molybdenum and metal sources, either in the slurry or by impregnation. Suitable phosphorous sources include but are not limited to phosphoric acid and phosphorous pentoxide.

Further, tungsten may also be incorporated in the hydropyrolysis catalyst as an active metal species. If present, the content of the tungsten in the hydropyrolysis catalyst is typically in an amount in the range of from 1 wt& to 20 wt %, preferably from 5 wt % to 10 wt %, based on the overall weight of the catalyst.

The slurry is formed by mixing the alpha alumina, non-alpha alumina precursor, optionally the sources of molybdenum and metal selected from those in groups 8, 9 and 10 of the periodic table, with a binder and water. The binder is preferably selected from one or more of polyvinyl alcohol, polyethylene glycol, poly acrylic acid and, polyvinyl pyrrolidone. Any suitable method of mixing the slurry may be used.

Preferably, water is used in an amount that the slurry has a solids content in the range of from 20 to 45 wt %. Also, the slurry preferably has a viscosity in the range of from 100 to 1000 cP. Further, the slurry suitably has a pH in the range of from 2 to 7.

The slurry is then subjected to a spray granulation process. This may be a “batch” type spray granulation process, such as that described in, for example, J. Chen, H. Yang, C.-M. Xu et al Powder Technology 385 (2021) 234-241; A. Tabeei, A. Keikhosravani, A. Samimi, D. Mohebbi-Kalhori, M. Zakeri Chemical Engineering Research and Design 172 (2021) 242-253; H. Takasaki et al, International Journal of Pharmaceutics 557 (2019) 18-25; Z. Chen, Y. Tang, Z. Gao et al. Journal of Process Control 118 (2022) 16-25; or P. Suresh et al., Materials Today: Proceedings 24 (2020) 519-530. However, it is preferred that the spray granulation process is a continuous process.

In a continuous spray granulation process, the slurry is suitably sprayed into a bed of seed particles of the desired catalyst or carrier, which are fluidised with a heated air flow. During the spray granulation process, solid discharge is continuously removed from the fluidised bed and is sifted. Any under-sized particles removed in the solid discharge are returned to the fluidised bed. Any oversized particles are crushed or ground and then returned to the fluidised bed.

The desired particle size of catalyst or carrier spheres produced in the spray granulation process is preferably in the range of from 0.30 mm to 0.60 mm, more preferably in the range of from 0.40 mm to 0.60 mm, and most preferably in the range of from 0.45 mm to 0.55 mm.

Preferably, the catalyst or carrier spheres will have a sphericity in the range of from 0.94 to 0.95.

The catalyst or carrier spheres are then dried and calcined. The drying temperature under which the step of drying the catalyst or carrier spheres is conducted should not exceed a calcination temperature. Thus, the drying temperature should not exceed 400° C., and, preferably, the drying temperature at which the catalyst spheres is dried does not exceed 300° C., and, most preferably, the drying temperature does not exceed 250° C. It is understood that this drying step will, in general, be conducted at lower temperatures than the aforementioned temperatures, and, typically, the drying temperature will be conducted at a temperature in the range of from 60° C. to 150° C.

The catalyst or carrier spheres are then calcined in the presence of air or oxygen. Said calcination is preferably carried out at a temperature in the range of from at least 450° C. and at most 900° C. Within this temperature range, calcination will lead to the formation of one or more aluminas other than alpha alumina. The formation of alpha alumina requires calcination at a higher temperature, e.g., 1050° C. or higher. Preferably the calcination is carried out at a temperature no higher than 700° C., more preferably no higher than 600° C. In the embodiment of the invention wherein the spheres are catalyst carrier spheres, the dried and calcined spheres are then impregnated with a solution of active species comprising a molybdenum source and a source of a metal selected from those in groups 8, 9 and 10 of the periodic table. The impregnation may be done by any suitable means or method known to those skilled in the art. Such method may include standard impregnation by incipient wetness or even soaking the shaped support with an excess amount of the metal-containing impregnation solution than would be used in a dry impregnation or an incipient wetness impregnation. A typical method of carrier impregnation is pore volume impregnation, which involves using an amount of the impregnation solution equivalent to that required to fill the pore volume of the catalyst carrier present.

The concentration of the metal sources in the solution of active species is selected so as to provide the desired metal content in the hydropyrolysis catalyst, taking into consideration the pore volume of the carrier spheres. Typically, the concentration of each of the metal compounds in the solution is in the range of from 0.01 to 10 moles per litre.

The impregnated carrier spheres are then dried and calcined. As with the previous drying step, the drying temperature under which the step of drying the fully impregnated carrier is conducted should not exceed a calcination temperature. Thus, the drying temperature should not exceed 400° C., and, preferably, the drying temperature at which the impregnated carrier spheres are dried does not exceed 300° C., and, most preferably, the drying temperature does not exceed 250° C. It is understood that this drying step will, in general, be conducted at lower temperatures than the aforementioned temperatures, and, typically, the drying temperature will be conducted at a temperature in the range of from 60° C. to 150° C.

The dried impregnated carrier spheres are then calcined in the presence of air or oxygen. Said calcination is preferably carried out at a temperature in the range of at least 450° C. and no more than 900° C. Preferably the calcination is carried out at a temperature no higher than 700° C., more preferably no higher than 600° C.

A typical hydropyrolysis process in which the catalyst prepared according to the process of the invention may be used is now described. This process is non-limiting and is used here in merely to illustrate the effect of the present invention.

A hydropyrolysis process generally comprises supplying a biomass feedstock and fluidising gas comprising hydrogen to a fluidised bed reactor comprising a deoxygenating or “hydropyrolysis” catalyst that is operating at an elevated temperature and pressure. The term “hydropyrolysis” is used generally to refer to a process by which a biomass feedstock is rapidly heated and thermally decomposed, in the presence of solid catalyst particles in an atmosphere consisting largely of hydrogen gas. The hydropyrolysis process provides a means to remove oxygen from biomass and other feedstocks containing significant quantities of carbon and chemically bonded oxygen to produce light hydrocarbons products with a large portion of the oxygen removed from the feedstock-derived liquid. A representative hydropyrolysis process has been described in detail in, among others, U.S. Pat. Nos. 8,492,600 and 8,841,495.

A fluidised bed reactor of a typical hydropyrolysis process generally comprises a mixing zone, a bulk reactor zone and optionally, an expanded solids disengagement zone (i.e., a section of expanded reactor diameter or cross-sectional area, relative to the diameter or cross-sectional area of the fluidised bed) at a suitable height above the bulk reactor zone in order to promote the separation of solid char particles from solid catalyst particles. The fluidised bed reactor further comprises one or more downcomers fluidly connecting the bulk reactor zone located at or near the top of the reactor to the mixing zone located at or near the bottom part of the reactor.

Fluidisation in the mixing zone and bulk reactor zone of the fluidised bed reactor may be performed with a fluidising gas having a superficial velocity effective for carrying out the type of fluidisation desired (e.g., bubbling bed fluidisation), considering the properties of the biomass feedstock, conditions within the reactor, and the particular fluidising gas being used. In general, a fluidising gas comprising hydrogen will have a superficial velocity of generally greater than about 0.1 meters per second (m/s) (e.g., from about 0.1 m/s to about 20 m/s), greater than 0.2 m/s (e.g. from about 0.2 m/s to about 1.5 m/s), typically greater than about 0.3 m/s (e.g., from about 0.3 m/s to about 1.2 m/s), and often greater than about 0.5 m/s (e.g., from about 0.5 m/s to about 1 m/s). Suitable fluidising gas streams comprise primarily hydrogen, but may also contain other non-condensable gases (e.g., CO, CO₂, and/or CH₄).

Preferably, the superficial gas velocity of the fluidising gas in the mixing zone is the same as or higher than that in the bulk reactor zone. Generally speaking, a higher superficial gas velocity in the mixing zone enables the use of larger biomass particles as compared to a standard fluidised bed as they do not sink to the bottom and form deposits. It is within the ability of one skilled in the art to select a suitable combination of superficial gas velocity, length of mixing zone and diameter of mixing zone, taking into consideration, for example, the rate at which the biomass feedstock is fed into the mixing zone, the amount of catalyst circulated and partial pressure of hydrogen within the reactor, the desired residence time of the biomass, catalyst, and fluidising gas, etc. It also within the ability of one skilled in the art to determine a suitable combination of superficial gas velocity, length of mixing zone and diameter of mixing zone such that backmixing of biomass from a bulk reactor zone located above the mixing zone is negligible, taking into consideration, for example, the dimensions of the mixing zone and the bulk reactor zone.

Conditions in the fluidised bed reactor include a temperature generally in the range of from 330° C. to 500° C., preferably from 350° C. to 480° C., more preferably from 370° C. to 450° C. The exact operating temperature depends upon the composition of the feedstock that is to undergo hydropyrolysis, the characteristics of the hydropyrolysis catalyst, and the desired composition of products that is to be obtained. The pressure within the reactor is typically in the range of from 0.50 MPa to 7.50 MPa. The exact operating pressure of the fluidised bed reactor depends upon the composition of the feedstock that is to undergo hydropyrolysis, the choice of catalyst, the composition of the fluidising gas (i.e., the hydrogen rich gas purity) and the desired composition of products that are to be obtained. The weight hourly space velocity (WHSV) in the reactor, calculated as the combined weight flow rate of the biomass feedstock, divided by the weight of the catalyst inventory in the reactor, is generally from about 0.1 hr⁻¹ to about 10 hr⁻¹, typically from about 0.5 hr⁻¹ to about 5 hr⁻¹, and often from about 0.8 hr⁻¹ to about 3 hr⁻¹. In general, the fluidisation velocity, catalyst size and bulk density and feedstock size and bulk density are chosen such that the deoxygenation catalyst remains in the fluidised bed, while the char produced gets entrained out of the reactor.

Such a hydropyrolysis processes produces a hydropyrolysis reactor output comprising a partially deoxygenated hydropyrolysis product (e.g., in the form of a condensable vapour), at least one non-condensable gas (e.g., CO, CO₂, and/or CH₄), and char particles. As used herein, the “partially deoxygenated hydropyrolysis product” may comprise oxygenated hydrocarbons (e.g., derived from cellulose, hemicellulose, and/or lignin) that may be subjected to more complete deoxygenation (e.g., to produce hydrocarbons and remove the oxygen in the form of CO, CO₂, and/or water) in a subsequent (downstream) hydroconversion process. Representative oxygen contents of the partially deoxygenated hydropyrolysis product are generally in the range from about 1 to about 30% by weight, or from about 5 to about 25% by weight.

Following hydropyrolysis all, or substantially all, of the char particles and/or other solid particles (e.g., catalyst fines) are removed from the hydropyrolysis reactor output to provide a purified hydropyrolysis reactor vapour stream having a reduced char content. The method of char and catalyst fines removal is generally not limited and may include any method suitable for use with such hydropyrolysis processes. A preferred method of char and catalyst fines removal from the vapour stream is by cyclone separation. Catalyst particles may also be present in the hydropyrolysis reactor output and these will be separated. The catalyst produced by the process of the present invention advantageously has a suitable density to allow simple separation of the catalyst particles and their return to the fluidized bed without considerably heat loss.

The invention will now be further illustrated by reference to the following non-limiting examples.

### EXAMPLES

### Example 1 (Spray Granulated Carrier)

A suspension was prepared by combining 4469 g demineralized water, 1420 g of Almatiz CT 3000 SG Alfa alumina, 539 g of PB 950 pseudoboehmite alumina from PIDC, 622 g of boehmite alumina from Shell Catalyst and Technologies, 113 g of 65 wt % nitric acid and 338 g of a 10% polyvinyl alcohol solution. The suspension had a pH of 3.4 and total solids concentration of 30 wt %. This suspension was sprayed using a spray nozzle having 2 mm diameter with atomization air pressure of 1.4 bar, on 800 g Almatiz 3000 SG alfa alumina powder fluidized in a Procell LabSystem supplied by Glatt Ingenieurtechnik GmbH with an air flow of 110 Normal cubic meter per hour and a temperature of 100° C. The particles were allowed to agglomerate in the Procell LabSystem, and product was withdrawn using a sifter classifier attached with fluidization chamber. Sifter pressure was kept at 1.6 bar to collect particles with D50 greater than 400 microns (measured by CAMSIZER®). Particles with D 50 less than 400 microns were fed back to the fluidized bed for further agglomeration. Once the required amount of the product was collected, slurry spraying was stopped. Collected product was then dried in an oven at 140° C. for 2 hours, followed by calcination at 550° C. for 1 hr. Physical properties of the carrier spheres collected are summarised in Table 1.

TABLE 1

| | | | | Attrition |
|---|---|---|---|---|
| | | Average | | loss/hr |
| Particle | Water Pore | Particle | | measured |
| Density, | volume, | size D50, | | by ASTM D |
| g/cc | cc/g | microns | Sphericity | 5757, wt % |
| 1.5 | 0.36 | 496 | 0.96 | 2.6 |

The calcined carrier spheres were then impregnated with an acidic solution comprising cobalt, molybdenum and phosphorous, to make a catalyst containing 2.3 wt % cobalt and 8 wt % molybdenum. After impregnation, the catalyst was dried at a temperature of 120° C. for 6 hours, and then calcined at a temperature of 500° C. for 1 hour. Physical properties of the catalyst spheres collected are summarised in Table 2.

TABLE 2

| | | | | Attrition |
|---|---|---|---|---|
| | | Average | | loss/hr |
| Particle | Water Pore | Particle | | measured |
| Density, | volume, | size D50, | | by ASTM D |
| g/cc | cc/g | microns | Sphericity | 5757, wt % |
| 2 | 0.25 | 496 | 0.96 | 1.5 |

### Example 2 (Spray Granulated Catalyst)

A suspension was prepared by combining 1977 g demineralized water, 453 g of Almatiz CT 3000 SG Alfa alumina, 411 g of PB 950 pseudoboehimite alumina from PIDC, 113 g of rejuvenated spent catalyst powder, 144 g of cobalt nitrate, 126 g of molybdenum trioxide and 100 g of 10% polyvinyl alcohol solution. The suspension had a pH of 4.5 and total solids concentration of 30 wt %. This suspension was sprayed using a spray nozzle having 2 mm diameter with atomization air pressure of 1.4 bar, on 800 g Almatiz 3000 SG alfa alumina powder fluidized in a Procell LabSystem supplied by Glatt Ingenieurtechnik GmbH with an air flow of 110 Normal cubic meter per hour and a temperature of 100° C. The particles were allowed to agglomerate in the Procell LabSystem, and product was withdrawn using a sifter classifier attached with fluidization chamber. Sifter pressure was kept at 1.6 bar to collect particles with D50 greater than 400 microns (measured by CAMSIZER®). Particles with D 50 less than 400 microns were fed back to the fluidized bed for further agglomeration. Once the required amount of the product was collected, slurry spraying was stopped. Collected product was then dried in an oven at 140° C. for 2 hours, followed by calcination at 500° C. for 1 hr. Physical properties of the catalyst product collected are summarised in Table 3.

TABLE 3

| | | | | Attrition |
|---|---|---|---|---|
| | | Average | | loss/hr |
| Particle | Water Pore | Particle | | measured |
| Density, | volume, | size D50, | | by ASTM D |
| g/cc | cc/g | microns | Sphericity | 5757, wt % |
| 2 | 0.28 | 407 | 0.96 | 2 |

### Example 3

The hydropyrolysis catalyst samples prepared in Examples 1 and 2 were used as 1^{st} upgrading catalysts in bubbling fluidized bed reactors according to the following procedure.

The hydropyrolysis catalyst samples were ground and sieved to a particle size range of 300 micron to 500 micron and loaded into a first reactor. A second, hydrotreating, catalyst (containing nickel and molybdenum on alumina) (CAT B) was dried to remove moisture before weighing. The thus-dried catalyst, in the form of extrudates of 1.3 mm diameter and approximately 3 mm to 6 mm length, was used as the second hydrotreating catalyst in a second, fixed bed reactor. Neither the hydropyrolysis catalyst nor the hydrotreating catalyst underwent any activation treatment (such as sulfidation) prior to loading in the reactors.

The solid feedstock used was sawdust generated in a paper and pulp mill as a co-product. The sawdust was sieved to a particle size of 250 micron to 500 micron. The hydropyrolysis catalyst in the 1st reactor was fluidized with a stream of hydrogen preheated to a temperature of approximately 435° C. After the hydropyrolysis catalyst had been fluidized, the biomass was introduced into the first reactor and processed in a continuous manner. The rate of processing of biomass was gradually ramped up to the target rate of 4.14 g/min, corresponding to a weight hourly space velocity of the biomass feedstock to the first reactor of approximately 1.26 kg biomass per kg catalyst per hour. The weighted average temperature of the fluidized bed of catalyst was 414.0° C. over the duration of biomass processing. The biomass feedstock was converted to a mixture of char, ash and vapours in the first reactor. The fluidization velocity was adjusted in such a way that the solid products (char, ash) and the vapour phase products were carried out of the reactor, while the catalyst remained in the reactor. Some catalyst was attrited into fines, and the fines were carried out of the bed as well. The solid product was separated from the vapour phase product in a filter and the vapours were sent to the second, fixed bed, reactor.

The average temperature of the second, hydrotreating, catalyst was maintained at 388.0° C. The biomass feeding rate was gradually ramped up to the final WHSV to the 2^{nd} stage of 0.36 kg biomass per kg catalyst per hour. Operating pressure for both the first and second reactors was 22.6 barg.

The vapour phase product of second reactor was cooled in stages to −46° C. and a two-layer liquid product containing a hydrocarbon layer floating on an aqueous layer was recovered. The hydrocarbon liquid was separated from the aqueous liquid and was analysed. The off gas from the process was sent to an online GC, and composition of the gas was analysed throughout the run. The mass balance and carbon balance of the process was calculated from the mass and analysis of the liquid products and compositional information of the gas product, based on which the yield profile was calculated. It was found that the hydrocarbon liquid product contained essentially no oxygen (below the detection limit of the instrument or <0.01 wt. %), and the aqueous product produced contained only 0.01 wt & carbon. Thus, complete hydrodeoxygenation of the biomass was achieved producing an oxygen-free hydrocarbon product, and substantially carbon-free aqueous phase. Results are summarized in Table 4. Table 4 also contains “standard range” results which are expected levels obtained when a typical hydrotreating catalyst containing cobalt and molybdenum on alumina (CAT A) is used as the first stage ‘hydropyrolysis’ catalyst.

TABLE 4

| | | | |
|---|---|---|---|
| | | Standard | Catalyst from |
| Parameter | Unit | Range | Example 1 |

| | | |
|---|---|---|
| First Stage | CAT A | Catalyst from |
| Catalyst | | Example 1 |

| | |
|---|---|
| Second Stage | CAT B |
| Catalyst | |

| | | | |
|---|---|---|---|
| Hydrogen | % wof MAF | 4-6 | 4.87 |
| addition | | | |
| 1st Stage WABT | ° C. | 400-430 | 415 |
| 2nd Stage WABT | ° C. | 340-370 | 360 |
| Pressure | barg | ~22.4 | 22.4 |
| C4+ | % wof MAF | 24-28 | 27.2 |
| Hydrocarbon | | | |
| yield | | | |
| C1-C3 | % wof MAF | 10-20 | 13.7 |
| Hydrocarbon | | | |
| yield | | | |
| CO + CO₂ Yield | % wof MAF | 1-10 | 7.7 |
| Water yield | % wof MAF | 35-50 | 40.9 |
| Char yield | % wof MAF | 10-20 | 10.6 |

These results demonstrate that the catalyst made in Example 1 provides results in the conversion of biomass, via hydrodeoxygenation, hydropyrolysis and hydroconversion processes, that are within desirable ranges when compared to a standard process. However, the catalysts made in Examples 1 and 2 has a higher particle density (2 g/cm³) compared to a standard catalyst (CAT A—1 g/cm³) used in a typical process. This allows an improved downcomer flux in a fluidised bed reactor and excellent fluidisation behaviour within the bed, providing efficient heat management across the reactor system.

1. A method of preparing a hydropyrolysis catalyst, said process comprising the steps of:
i) forming a slurry comprising alpha alumina, an alumina precursor, a binder and water;
ii) performing spray granulation of said slurry to prepare solid catalyst or carrier spheres; and
iii) drying the catalyst or carrier spheres and then calcining them at a temperature in the range of at least 450° C. and no more than 900° C., wherein active species comprising a molybdenum and a metal selected from those in groups 8, 9 and 10 of the periodic table are incorporated into the hydropyrolysis catalyst, either by incorporating a molybdenum source and a source of a metal selected from those in groups 8, 9 and 10 of the periodic table into the slurry in step i) or by impregnating the calcined carrier spheres with a solution comprising a molybdenum source and a source of a metal selected from those in groups 8, 9 and 10 of the periodic table and subsequently drying and then calcining at a temperature in the range of at least 450° C. and no more than 900° C. the thus-impregnated carrier spheres to provide the hydropyrolysis catalyst.

2. A method as claimed in claim 1, wherein the alpha alumina has a particle density of at least 3.5 g/cm3 and no more than 4.5 g/cm3.

3. As method as claimed in claim 1, wherein the alumina precursor is selected from one or more of boehmite, pseudoboehmite, gibbsite and bayerite.

4. A method as claimed in claim 1, wherein the metal source is incorporated in an amount to provide a metal content of the metal selected from those in groups 8, 9 and 10 of the periodic table in the hydropyrolysis catalyst in an amount in the range of from 0.5 wt % to 20 wt %, more preferably from 1 wt % to 15 wt %, and, most preferably, from 2 wt % to 12 wt % based on the overall weight of the catalyst.

5. A method as claimed in claim 1, wherein the molybdenum source is incorporated in an amount to provide molybdenum in the hydropyrolysis catalyst in an amount in the range of from 5 wt % to 50 wt %.

6. A method as claimed in claim 1, wherein the binder is selected from one or more of polyvinyl alcohol, polyethylene glycol, poly acrylic acid and polyvinyl pyrrolidone.

7. A method as claimed in claim 1, wherein the spray granulation is carried out as a continuous spray granulation process.

8. A method as claimed in claim 1, wherein the particle size of catalyst or carrier spheres produced in the spray granulation process is in the range of from 0.30 mm to 0.60 mm.

9. A method as claimed in claim 1, wherein the calcination is carried out at a temperature no higher than 700° C., preferably no higher than 600° C.

10. A process for the hydropyrolysis of biomass, said process comprising the steps of contacting biomass with a hydropyrolysis catalyst in a bubbling fluidised bed reactor under a hydrogen atmosphere, wherein the hydropyrolysis catalyst is produced according to the method of claim 1.
